(19) United States
(12) Patent Application Publication
(10) Pub. No.: US 2026/0368087 A1
(43) Pub. Date: Nov. 19, 2026

(54) FREQUENCY-BASED DATA PLACEMENT

(71) Applicant: Hewlett Packard Enterprise Development LP, Spring, TX (US)

(72) Inventors: Narayanan Balakrishnan, Bangalore Karnataka (IN); Adil Babu Mohammed, Bangalore Karnataka (IN); Prasanna Venkatesh Srinivasan, Bangalore Karnataka (IN); Subramani Nallusamy, Bangalore Karnataka (IN)

(21) Appl. No.: 19/280,288

(22) Filed: Jul. 25, 2025

(30) Foreign Application Priority Data
May 14, 2025 (IN) 202511046264

(51) Int. Cl. G06F 12/02

(52) U.S. Cl. CPC G06F 12/0253; G06F 2212/7205

(57) ABSTRACT

Techniques are provided herein for frequency-based placement of data within segments of a storage device. Data is coalesced with other data having a similar generation number and/or similar carry forward index (CFI) into a common segment, resulting in segments storing data with similar generation numbers and/or similar CFIs.

### BACKGROUND

Many storage systems, such as storage arrays, use a log-structured file system (LFS), where data write input/output (IOs) (e.g., write operations)—new or overwrite—are stored sequentially in a log structure. For example, a write IO may provide a logical block address (LBA) as an indication of a location of where in a storage volume to store data the write IO. The LBA maps to physical storage in one or more storage devices where the data is to be physically stored. Data of multiple write IOs may be coalesced and stored together in a free segment of the LFS.

A write IO that overwrites previously stored data (e.g., by targeting an LBA that was previously written to) may be referred to herein as an overwrite operation. In response to an overwrite operation, the new data to be written by the write IO is stored in a free segment different than the segment to which the previously stored data was written, and the previously stored data being overwritten is invalidated, becoming “invalid data” in the previously written segment. Such overwrite operations may result in fragmentation of segments, in which segments contain both data that has not been overwritten (“valid data” herein) and invalid data. The invalid among valid data within a segment may be referred to herein as “holes” within a segment.

Periodically, a garbage collection process may be performed to defragment the fragmented segments. In such examples, the valid data within a fragmented segment may be copied forward to a new, free segment, such that the fragmented segment may be freed for future storage of valid data, without losing the valid data that remained in the segment when it was fragmented.

### DRAWINGS

These and other features, aspects, and advantages of the present disclosure will become better understood when the following detailed description is read with reference to the accompanying drawings, wherein:

FIG. 1 is a schematic diagram, illustrating an example system that includes a storage system that provides frequency-based placement of data, in accordance with aspects of the present disclosure;

FIG. 2 is a flowchart, illustrating an example process for frequency-based placement of data, in accordance with aspects of the present disclosure;

FIG. 3 is a flowchart, illustrating an example garbage collection process that implements frequency-based placement of data, in accordance with aspects of the present disclosure;

FIG. 4 is a flowchart, illustrating an example process for frequency-based placement of data of pending data write IOs, in accordance with aspects of the present disclosure; and

FIGS. 5A-5C are schematic diagrams, illustrating an example frequency-based placement of data, in accordance with aspects of the present disclosure.

### DETAILED DESCRIPTION

In examples described herein, a storage system may receive write input/outputs (IOs) targeting logical block addresses (LBAs) of volume(s) implemented by the storage system. In some examples, the storage system may utilize a log-structured file system (LFS) to store data. In such examples, data from one or more write IOs may be coalesced for storage in a free segment of the LFS. In such examples, a first write IO may write first data to a given LBA, and the storage system may store the first data in a first segment of the LFS. An overwrite may occur when a subsequent write IO writes second data to the same LBA. As a result of such an overwrite, the storage system may invalidate the first data in the first segment (such data that is invalidated may be referred to as “invalid” data herein), and may write the second data to a different, free segment in the LFS. In such examples, data that has not been invalidated may be referred to herein as “valid” data. In such examples, overwrites may invalidate data in previously written segments of the LFS resulting in invalid data (or holes) between valid data within respective segments, which may be referred to herein as “fragmented” segments (i.e., containing both valid and invalid data). Such fragmented segments may reduce the useable capacity of the storage system, as the invalid data continues to occupy storage space until the entire segment is freed, thereby “trapping” the space occupied by invalid data in a segment while the segment contains any valid data.

A garbage collection process may be used to reduce the fragmentation of the segments within the storage system (which may be referred to herein as “defragmentation”). Such garbage collection may include identifying a segment that is fragmented (containing valid and invalid data), copy forward the valid data into a free segment, and then free the identified segment (once the valid data has been preserved elsewhere). In this manner, a garbage collection process may free the identified segment containing invalid data while also preserving the valid data by copying it forward into another (free) segment. In some examples, the garbage collection process may coalesce valid data from multiple fragmented segments into one or more free segments, which may thereby reduce the overall fragmentation of the LFS. However, garbage collection processes may be quite resource intensive and may struggle to keep pace with the fragmentation caused by overwrite operations. For example, while a garbage collection process works to reduce fragmentation (e.g., as a background process), new overwrite operations may create new holes and thus increase fragmentation in segments of the storage system. In such examples, the newly introduced holes may result in more rounds of garbage collection, which may result in frequent copying forward of valid data to free segments, which may use significant processing resources that could otherwise be used for processing incoming operations. In some cases, the garbage collection process may be unable to keep up with the fragmentation introduced by overwrites and thus may not be able to free enough segments for incoming write IOs, which may result in insufficient capacity for storing data of incoming write IOs. This may result in a client system experiencing increased latency for write IOs to the storage system.

To address these issues, examples described herein provide techniques for frequency-based placement of data within segments of a storage system, which may result in less copying forward of valid data by garbage collection processes and may thus improve the efficiency of processing resource utilization within the storage system. In some examples, valid data associated with similar frequency statistics may be coalesced (grouped) together in a common segment. For example, when copying forward valid data in identified segments of an LFS as part of a garbage collection process, the garbage collection process may divide (at least some) of the valid data to be copied forward into groups of data based on similarity of the number of overwrite operations for respective LBAs associated with the data and/or similarity in the number of times that respective data has been copied forward (in a garbage collection operation). In such examples, each group of data is written to a respective free segment such that each respective free segment is filled with valid data associated with similar frequency statistics. Performing such frequency-based coalescing of valid data with similar frequency statistics into a common segment, applied for many segments of the LFS when coalescing data into segments, may reduce fragmentation within segments of the LFS. For example, valid data written to LBAs that are less frequently overwritten may be considered more stable, and valid data copied forward (in garbage collection) more times without being overwritten may be considered more stable. In contrast, valid data written to LBAs that are more frequently overwritten may be considered less stable, and valid data copied forward (in garbage collection) relatively few times without being overwritten may be considered less stable. Coalescing more stable valid data together in a segment with other similarly stable data may result in fewer holes being created in the segment and, when applied for many segments of the LFS when coalescing data into segments, may result in less fragmentation within the segments of the LFS.

For example, coalescing less stable data (e.g., associated with more frequently overwritten LBAs, fewer copy forward operations, or a combination thereof) with more stable data (e.g., associated with less frequently overwritten LBAs, more copy forward operations, or a combination thereof) may increase the likelihood of that segment becoming fragmented, as the less stable data in the segment may be invalidated alongside more stable data remaining valid within the segment. In contrast, examples described herein may coalesce relatively stable valid data together in a common segment exclusively with other relatively stable valid data (e.g., based on the similarity of frequency statistics indicating relative stability). Segments produced in this way are less likely to be fragmented by overwrites than segments with a mixture of more and less stable data according to the frequency statistics. Some examples described herein may coalesce less stable valid data together in a common segment exclusively with other less stable valid data (e.g., based on the similarity of frequency statistics indicating relative instability). Producing segments in this way may increase the likelihood that more of (or even all) the data within these segments will be invalidated within a given amount of time prior to garbage collection which may also improve garbage collection efficiency by creating segments likely to have less valid data to copy forward when these segments are selected for garbage collection.

Accordingly, to reduce the defragmentation (garbage collection) workload and associated resource utilization, examples described herein may coalesce data with similar frequency statistics into a particular segment. For example, pending data (i.e., data to be written to a segment (e.g., either due to a pending write operation and/or a pending garbage collection operation)) may be coalesced with other pending data having a common range of volatility and/or stability (e.g., as indicated by their frequency statistics). In this manner, data with similar levels of volatility and/or stability may be stored in common segments, which may result in reduced fragmentation within the segments and, thus, a reduced defragmentation workload.

Specifically, two frequency statistics may be maintained for written data and LBAs to which that data has been written. One, which may be referred to as a “generation number” herein, may be a count of a number of times data is written to a particular LBA, indicating a number of overwrites of data associated with that LBA. Another, which may be referred to as a “copy forward index” (CFI) herein, may be a count of a number of times that given data written to an LBA has been copied forward as part of a defragmentation operation without being overwritten (e.g., which may be indicated by an unchanged generation number associated with that LBA). When given data written to a particular LBA is copied forward by a garbage collection (defragmentation) operation, the generation number associated with the particular LBA may be incremented. When the given data written to the particular LBA is overwritten by writing new data to the particular LBA, the CFI associated with data the particular LBA may be reset to zero and thereafter maintain a count of times the new data is copied forward.

LBAs having higher generation numbers may indicate that the data associated with those LBAs is less stable (more volatile) and is more likely to be frequently overwritten, while LBAs having lower generation numbers may indicate that the data associated with those LBAs is more stable (less volatile) and is less likely to be frequently overwritten. Data having a higher CFI may indicate more stable data that is overwritten less frequently, as a higher CFI indicates that the associated data is repeatedly copied forward as a valid data to a free segment during a garbage collection operation. Data having a lower CFI may indicate less stable data that is overwritten more frequently, as a lower CFI may indicate that the data has not been copied forward as a valid data as often. In some cases, the generation number and/or the CFI associated with data written to a storage volume may be maintained based upon statistics of corresponding logical block addresses (LBAs). For example, the generation number may be incremented when data is written to a given LBA by the data writing system. Further, the CFI for an LBA may be set to zero when data is written to the LBA for the first time, and may be reset to zero when data associated with the LBA is overwritten. The CFI may be incremented for an LBA when valid data associated with the LBA is copied forward to a free segment.

Coalescing the data in this manner may significantly reduce the defragmentation workload. For example, by coalescing data with similar generation numbers and/or CFIs into a segment, there may be less fragmentation within the segment in the future. With such coalescing of data in segments, it may be more likely that all data within that segment will remain valid (e.g., not overwritten) and/or become invalid (e.g., overwritten) within a similar time frame and/or at a similar rate, resulting in less de-fragmentation workloads for a garbage collection process. For example, all or a large portion of these commonly situated data within a segment may become overwritten within a common time period (e.g., because they are within a common range of more-frequent overwriting), freeing up the segment while reducing and/or eliminating copy forwards of valid data (e.g., because all or a large portion of the data are invalid). Further, in another segment, all or a large portion of the data of a segment may remain valid for an extended period of time (e.g., because they are within a common range of less-frequent overwriting). This may result in less fragmentation (e.g., fewer holes) in the segment, because there are fewer overwritten/invalid data in the segment. Thus, copy forward operations for these segments may be delayed/reduced.

Accordingly, examples described herein may provide frequency-based placement of data within segments of storage system. By placing data with similar generation numbers and/or CFIs in common segments, a garbage collection workload may be reduced, for example because less fragmentation may occur within the segments and/or there may be less data to copy forward from fragmented segments, which may significantly reduce the amount of processing resources utilized for garbage collection.

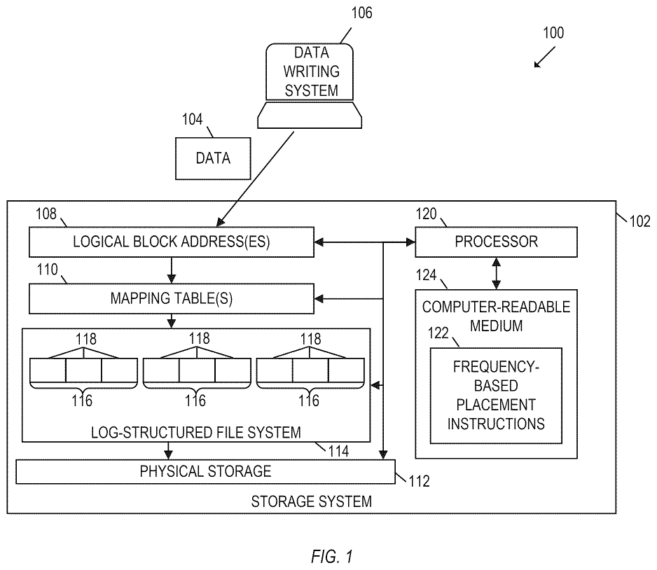

With this in mind, FIG. 1 is a schematic diagram, illustrating a system 100 that includes a storage system 102, such as a storage array, that provides frequency-based placement of data 104 (e.g., for garbage collection processing efficiencies), in accordance with aspects of the present disclosure. As illustrated, a data writing system 106 may provide data 104 via one or more write IOs (e.g., write operations or overwrite operations) supplied to the storage system 102.

The data writing system 106 may provide a particular logical block address (LBA) of the LBAs 108 indicating where the data 104 should be written. A mapping table 110 may map (e.g., via one or more page table entries) the LBAs 108 to a portion of the physical storage 112 associated with a particular one or more portions 118 of a free segment of the one or more segments 116 of the log-structured file system 114.

To write the data 104 to segments 116, a processor 120 may execute computer-readable instructions (frequency-based placement instructions 122) stored on a non-transitory computer-readable medium 124 that are executable by the processor 120. Implementing the frequency-based placement instructions 122 may cause the processor 120 to coalesce portions of data 104 having similar frequency statistics and write the coalesced portions of data 104 to a free segment of the one or more segments 116. In some cases, the frequency-based placement instructions 122, when implemented by the processor 120, may cause the processor 120 to track certain frequency statistics associated with the data 104. For example, the processor 120 may maintain a generation number, which is a count of overwrites to each of the LBAs 108 (e.g., as indicated by the LBA provided with the data 104 from the data writing system 106). Further, the processor 120 may maintain a copy-forward index (CFI), which is a count of the number of times that respective data 104 of an LBA is copied forward to a free segment of the segments 116 (e.g., as part of a garbage collection process) without being overwritten.

The processor 120 may coalesce subsets of the data 104 having similar frequency statistics for placement into a common segment. For example, a first subset of data 104 having frequency statistics in a first range of generation numbers and first range of CFI values may be coalesced and stored in a first segment of the segments 116 and a second subset of the data 104 having frequency statistics in a second range of generation numbers different than the first range of generation numbers and a second range of CFI numbers different than the first range of CFI values may be coalesced and stored in a second segment of the segments 116. In some examples, processor 120 executing instructions 122 may subdivide data 104 from write IOs or copy forward operations into respective groups of data having similar frequency statistics and each group may be written to a respective free segment, such that the data written to a given segment have similar frequency statistics. In such examples, data may be written to the same segment (i.e., a common segment) as other data having similar frequency statistics. In some examples, the similarity of frequency statistics may be based on ranges of generation numbers and/or ranges of CFI values. In examples in which the amount of data that may be grouped together into a common segment based on the similarity of frequency statistics may exceed the size of a segment. In such examples, that data may be subdivided into several groups (each having similar frequency statistics) and each of the several groups of data may be written to a respective segment, such that each segment include data with similar frequency statistics, though data in other segments may also have similar frequency statistics.

As discussed in more detail below, the frequency-based placement of the data 104 may occur when data 104 is to be stored in a free segment of the segments 116. For example, this may occur when a new write IO is provided from the data writing system 106 and/or when the storage system 102 (e.g., via the processor 120) implements garbage collection processes that result in valid data being copied forward to a free segment of the segments 116 to free up a fragmented segment of the segments 116.

In this manner, the coalesced subsets of the data 104 having similar frequency statistics may be written to a common free segment of the segments 116. As discussed herein, this may result in decreased fragmentation within each of the segments 116, as there may be a greater likelihood that all (or a significant portion) of the data with similar frequency statistics will remain valid for a similar amount of time. Thus, fewer holes may appear within a segment 116, resulting in a reduced defragmentation workload for a garbage collection process.

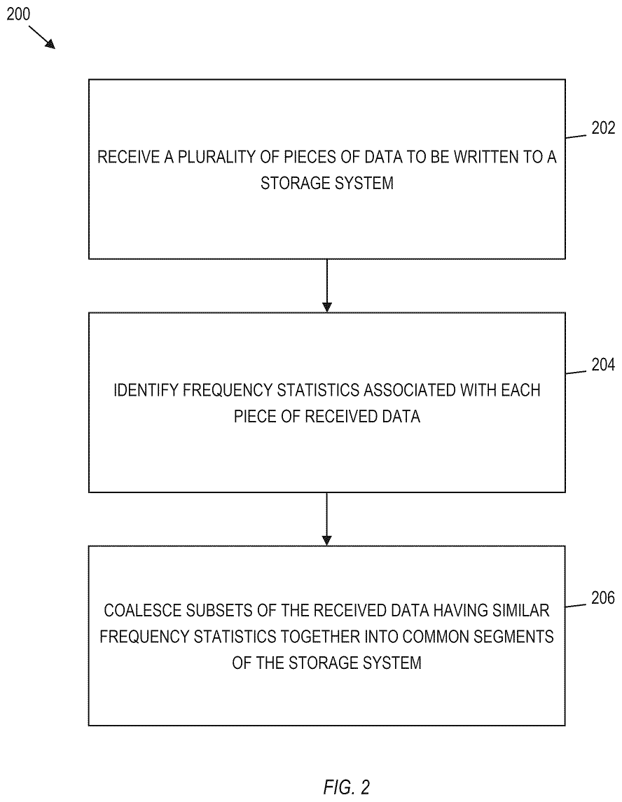

FIG. 2 is a flowchart, illustrating a process 200 for frequency-based placement of data (e.g., data 104 of FIG. 1), in accordance with aspects of the present disclosure. The process 200 may be a processor-implemented method, which may be implemented, for example, via implementation of the frequency-based placement instructions 122 by the processor 120 of FIG. 1.

The process 200 includes receiving a plurality of pieces of data to be written to a storage system (e.g., storage system 102 of FIG. 1) (block 202). Specifically, one or more data writing systems (e.g., data writing system 106 of FIG. 1) may provide write IOs, indicating data (e.g., data 104 of FIG. 1) to write or overwrite to a particular LBA.

For reduced fragmentation and, thus, reduced garbage collection workloads, data may be coalesced with other data having similar characteristics for storage in a common segment. For example, frequency statistics associated with the data may indicate particular similarities between pieces of received data that make them suitable for placement within a common segment. Accordingly, the process 200 includes identifying frequency statistics associated with each piece of received data (block 204). The frequency statistics may include, for example, a volatility metric that may indicate how frequently an LBA associated with a given piece of data is overwritten (e.g., relative to other data written to the storage system (e.g., storage system 102 of FIG. 1)). In some cases, this volatility metric may be expressed by the generation number, which may be a count of a number of times data is written to a particular LBA, indicating a number of overwrites of data associated with that LBA.

Further, the frequency statistics may include a stability metric that indicates how stable (unchanging) the data is (e.g., relative to other data stored in the storage system). For example, the stability metric may be expressed in the form of the copy forward index (CFI), which may be a count of a number of times that given data has been copied forward, as part of a defragmentation operation, since that data was written. The CFI for given data may be associated with the LBA associated with that data. When new data is written to the LBA as part of a write IO, a CFI counter associated with the LBA may be set to zero. When data is copied forward to a free segment as part of the garbage collection processes, a CFI counter associated with the LBA may be incremented, indicating that the data associated with that LBA has been copied forward.

The frequency statistics may be stored at a number of locations within the storage system. For example, the frequency statistics may be stored in a location with data persistence (e.g., where data is retained across power cycles, controller failures, etc.). Further, for efficiency, the frequency statistics may be stored in a location accessed when implementing write operations and/or garbage collection processes that may use these frequency statistics. Accordingly, in some cases, the frequency statistics may be stored in mapping tables (e.g. mapping tables 110 of FIG. 1), and/or in segment headers of the segments (e.g., segments 116 of FIG. 1) where the data are written.

Once the frequency statistics associated with the data are determined, the process 200 includes coalescing subsets of the plurality of data having similar frequency statistics together into common segments of the storage system (block 206). Similarity of frequency statistics may be determined by identifying ranges of the frequency statistics to be grouped together. The ranges may be identified by dividing a full range or span of the identified frequency statistics into sub-ranges. The span of the identified frequency statistics may change over time and, thus, the sub-ranges may also change over time. Accordingly, in some cases, when the span of identified frequency statistics is relatively small, the sub-ranges may be a finer granularity relative to a granularity of the sub-ranges when the span of identified frequency statistics is relatively larger. For example, at the beginning of process 200, there may be little difference in frequency statistics of the data, as few overwrite operations and/or garbage collection processes have occurred. Thus, the sub-ranges used to identify similarity of frequency statistics between data may be a finer granularity. Over time, as new write IOs and/or garbage collection processes are performed, the frequency statistics may vary to a larger extent, resulting in an increased span of identified frequency statistics. Thus, the sub-ranges may be expanded to a coarser granularity to cover the increased span of identified frequency statistics. In some cases, the sub-ranges are identified by dividing the span into a pre-determined/defined number of equal sub-ranges. In some cases, however, sub-ranges may not cover equal portions of the span of identified frequency statistics. For example, finer-granularity sub-ranges may be used to cover a first portion of the span of identified frequency statistics where a relatively larger portion of the identified frequency statistics are distributed, and coarser-granularity sub-ranges may be used to cover a second portion of the span of identified frequency statistics where relatively fewer of the identified frequency statistics are distributed.

By coalescing subsets of the data having similar frequency statistics together into common segments, garbage collection efficiencies may be achieved. For example, this frequency-based coalescing may result in less fragmentation within segments, resulting in a reduced number and/or frequency of segments reaching a threshold amount of fragmentation. Further, when overwrites occur, this frequency-based coalescing may result in increased segments where all and/or more pieces of data within the segment become invalid prior to a defragmentation operation, resulting in fewer copy forward operations. Accordingly, this frequency-based coalescing of the data may significantly reduce processing resources expended by garbage collection processes, greatly improving efficiencies of the storage system.

The frequency-based coalescing techniques described herein may be implemented whenever pieces of data are stored in a free segment. For example, the frequency-based coalescing may occur during garbage collection processes, when valid data are copied forward to a free segment to free up a fragmented segment and/or when new data associated with a data write IO are received from a data writing system.

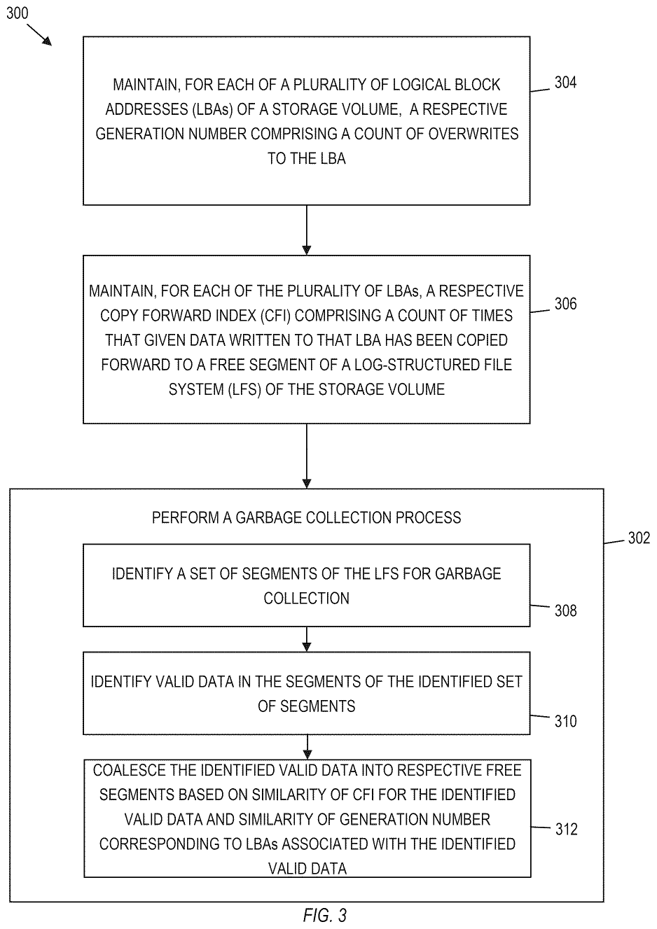

FIG. 3 is a flowchart, illustrating a process 300 that includes a garbage collection process 302 that implements frequency-based placement of data (e.g., data 104 of FIG. 1), in accordance with aspects of the present disclosure. The process 300 (e.g., including the garbage collection process 302) may be a processor-implemented method, which may be implemented, for example, via implementation of the frequency-based placement instructions 122 by the processor 120 of FIG. 1.

Each time an overwrite occurs, the valid data of the particular LBA may be stored in a free segment and the former data of the particular LBA becomes invalid. Accordingly, holes may form in a segment where the former data that has become invalid is stored. Some data are overwritten more frequently than other data. It may be beneficial to characterize this relative volatility of each of piece of the data associated with a pending write IO, such that pieces of data with relatively similar volatility levels (i.e., similar frequency of overwrites) are coalesced together in a common segment. Thus, process 300 includes maintaining, for each of a plurality of LBAs of a storage volume, a respective generation number comprising a count of overwrites to the LBA (block 304). As mentioned above, the generation number may be a count of a number of times data is written to a particular LBA, indicating a number of overwrites of data associated with that LBA. For example, each time a write IO of a data writing system (e.g., data writing system 106 of FIG. 1) provides data to be written to a particular LBA, a generation number counter associated with that particular LBA may be incremented. Thus, a count of the number of overwrites of data associated with the LBA may be maintained.

The process 300 also includes maintaining, for each of the plurality of LBAs, a respective CFI comprising a count of times that given data written to that LBA has been copied forward to a free segment of an LFS of the storage volume (block 306). When valid data is copied forward to a free segment as part of a garbage collection process that frees up fragmented segments, a CFI counter associated with that valid data may be incremented. When the valid data is overwritten, the CFI counter may be reset to zero. In this manner, the CFI may provide an indication of how stable the data is over time, by identifying how often the valid data is copied forward to a free segment without being overwritten.

The garbage collection may implement frequency-based placement of data that are copied forward to free segments as part of the garbage collection process 302. To do this, the garbage collection process 302 may use the generation numbers maintained at block 304 and the CFIs maintained at block 306 to perform a frequency-based placement of valid data copied forward as part of a defragmentation operation.

Specifically, the garbage collection process 302 may include identifying one or more sets of segments (e.g., fragmented segments) of the LFS for garbage collection (block 308). For example, the garbage collection process 302, in block 308, may identify fragmented segments meeting and/or exceeding a fragmentation threshold (e.g., a threshold percentage of allowable invalid data within the segment). For example, the fragmentation threshold may indicate that up to 30% of the segment may contain invalid data. Thus, when a segment exceeds this fragmentation threshold, the segment may be identified as a segment of the set of fragmented segments for garbage collection.

To free up the fragmented segments, the valid data within the fragmented segments may be copied forward to a free segment. Accordingly, the garbage collection process 302 includes identifying the valid data in the segments of the identified set of segments (block 310). The validity status of each data may be obtained, for example, by accessing an indication of validity from, for example, a mapping table (e.g., mapping table 110 of FIG. 1) which may indicate when data is overwritten by new data in a different free segment and, thus, is invalid.

The garbage collection process 302 then includes coalescing the identified valid data into respective free segments based on similarity of CFI for the identified valid data and similarity of generation number corresponding to LBAs associated with the identified valid data (block 312). For example, sub-ranges of CFI values and sub-ranges of generation number values may be used to identify valid data with similarity of CFI and/or similarity of generation number. Those valid data having similarity of CFI and/or similarity of generation number may be coalesced together into one or more common segments, while valid data not having similarity of CFI and/or not having similarity of generation number may be coalesced into separate free segments. In this manner, the data may be coalesced with other data having a similar volatility and/or stability, which may reduce fragmentation and/or a number of valid data to be carried forward during the garbage collection process 302.

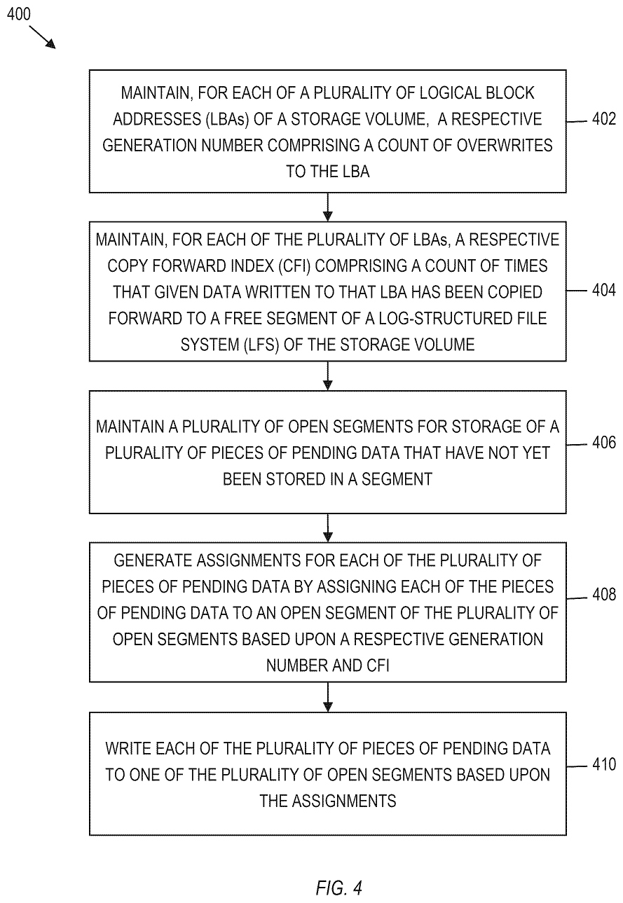

Turning now to a discussion of frequency-based placement of data of write IOs, FIG. 4 is a flowchart, illustrating a process 400 for frequency-based placement of data of pending data write IOs, in accordance with aspects of the present disclosure. The process 400 may be a processor-implemented method, which may be implemented, for example, via implementation of the frequency-based placement instructions 122 by the processor 120 of FIG. 1.

Similar to the process 300 of FIG. 3, the process 400 includes maintaining, for each LBA of a storage volume, a generation number, which may be a count of overwrites to the LBA (block 402). For example, as with process 300, each time a write IO of a data writing system (e.g., data writing system 106 of FIG. 1) provides data to be written to a particular LBA, a generation number counter associated with that particular LBA may be incremented. Thus, a count of the number of overwrites of data associated with the LBA may be maintained.

Further, similar to process 300 of FIG. 3, the process 400 includes maintaining, for each of the plurality of LBAs, a respective CFI comprising a count of times that given data written to that LBA has been copied forward to a free segment of the LFS of the storage volume (block 404). As in process 300, when valid data is copied forward to a different free segment as part of a garbage collection process that frees up fragmented segments, a CFI counter associated with that valid data may be incremented. When the valid data is overwritten, the CFI counter associated with that data may be reset to zero. In this manner, the CFI may provide an indication of how stable the data is over time, by identifying how often the valid data is copied forward to a free segment without being overwritten.

The process 400 includes maintaining a plurality of open segments (i.e., free segments ready for storage of valid data) for storage of a plurality of pieces of pending data that have not yet been stored in a segment (block 406). The plurality of open segments may enable coalescing data with similar generation numbers and CFIs into a particular open segment, by maintaining at least one open segment for each combination of range of similar generation numbers and range of similar CFIs. For example, as mentioned above, sub-ranges of a span of generation numbers and sub-ranges of a span of CFIs may be identified. One or more open segments may be maintained for each combination of one of the sub-ranges of the span of generation numbers and one of the sub-ranges of the span of CFIs.

Assignments for each of the plurality of pieces of pending data may be generated by assigning each of the pieces of pending data to an open segment of the plurality of open segments based upon a respective generation number and CFI (block 408). For example, each LBA associated with a piece of pending data may have a generation number within one of the sub-ranges of the span of generation numbers and a CFI within one of the sub-ranges of the span of CFIs. Accordingly, each piece of pending data may be assigned to one of the open segments for the combination of that piece of pending data's corresponding sub-range of the span of generation numbers and corresponding sub-range of the span of CFIs.

Each of the plurality of pieces of pending data is written to one of the plurality of open segments based upon the assignments (block 410). For example, when an open segment becomes full, meaning there are enough assigned pieces of pending data to fill the open segment and/or an open segment is a last open segment and all pieces of pending data have been assigned, the pieces of pending data assigned to the open segment may be written to the open segment.

There may be situations where there are not enough pending data having a similar generation number and a similar CFI to fill a corresponding open segment. For example, a timeout threshold may be assigned to each of the pieces of pending data, where the timeout threshold indicates an amount of time before an actual timeout (e.g., when the data will be deemed invalid because it has not been written to a segment). When a piece of pending data is within a corresponding timeout threshold (e.g., the pending data has been held an amount of time specified by the timeout threshold and/or between the timeout threshold and the actual timeout), the storage system may write the pending data to a different open segment, by reassigning the pending data, and/or may reassign other pending data to the partially full open segment to fill the partially full open segment. In this manner, writing of the pending data within the timeout threshold to a segment may be expedited (e.g., as opposed to continued waiting for additional data with a similar generation number and CFI) to avoid a time out with respect to the pending data within the timeout threshold.

In some cases, when the pending data within the timeout threshold is to be written to its assigned partially full open segment, prior to writing the assigned pending data to the partially full open segment, the partially full open segment may be filled by writing one or more additional pending data that are assigned to a second/different partially full open segment to the partially full open segment, such that a full segment may be written.

The additional pending data that is written to the partially full open segment may be selected based upon characteristics and/or the characteristics of the second/different partially full open segment that the additional pending data is assigned to. For example, in some cases, the additional pending data may be selected based upon having an actual timeout closest to the actual timeout of the pending data that is within the timeout threshold being written to the partially full open segment. In this manner, the additional pending data of other partially full open segments may be re-assigned, enabling the other partially full open segments to remain open for an extended duration. This may allow more time for these open segments to be filled with pending data within the generation number range and CFI range associated with those open segments.

In some cases, the additional pending data may be selected based upon finding data with the next-most-similar generation numbers and/or CFIs. This may be done, for example, by selecting data from a neighboring partially full open segment (e.g., a partially full open segment with a next closest sub-range of generation numbers and/or CFIs to the partially full open segment that the additional data are being written to).

Thus, the process 400 may greatly improve garbage collection efficiencies by writing pending data of pending write IOs with similar generation numbers and/or CFIs to a common segment. As discussed above, this may greatly reduce processing resource utilization for garbage collection.

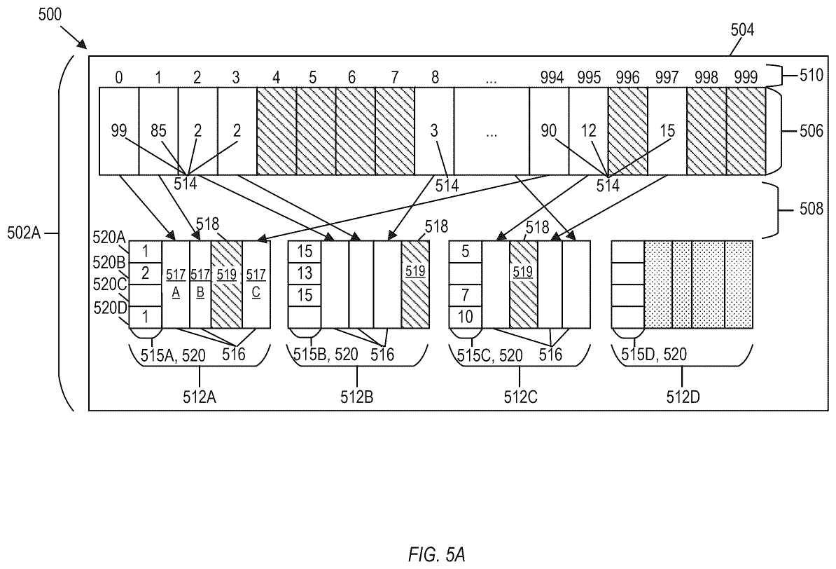

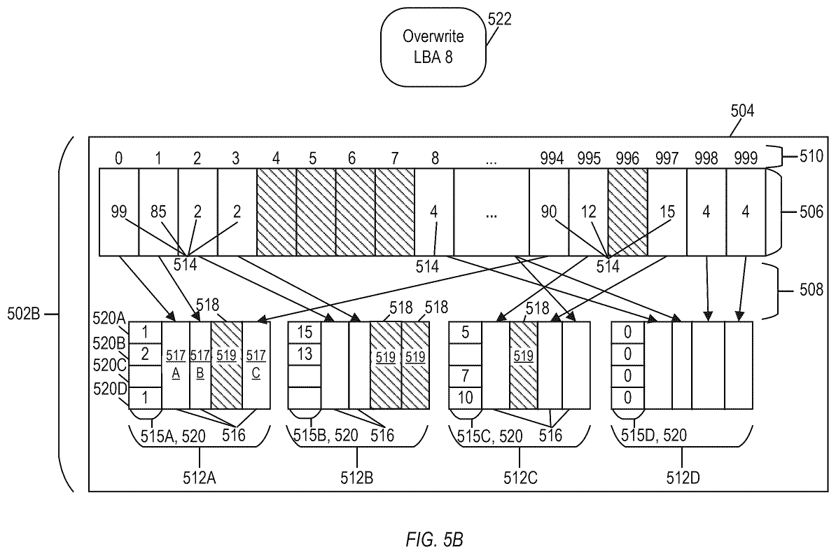

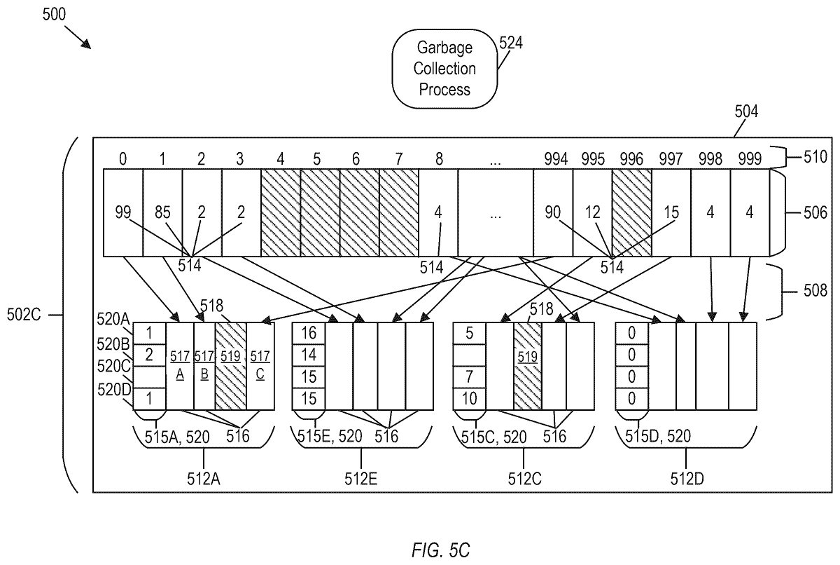

FIGS. 5A-5C, are schematic diagrams, illustrating an example 500 of frequency-based placement of data within segments, in accordance with aspects of the present disclosure. FIGS. 5A-5C respectively illustrate example progressions 502A-502C of a storage system 504 that implements frequency-based placement of data as described herein. In progression 502A of FIG. 5A, mapping tables 506 (e.g., mapping table(s) 110 of FIG. 1) may provide a mapping 508 between LBAs 510 (e.g., LBAs 108 of FIG. 1), herein represented by a simplified integer representation 0-999, and respective portions of physical storage corresponding to segments 512A-D, collectively referred to as segments 512 (e.g., segments 116 of FIG. 1). Though four segments are shown for illustrative purposes, there may be many more segments 512. A generation number 514 for each LBA where data has been written may be maintained in the mapping tables 506, such as in one or more page table entries of the mapping tables 506. Each time a write IO targets a particular LBA of the LBAs 510, the generation number 514 associated with that LBA may be incremented. In this manner, an overall volatility of the LBA and its underlying data may be measured. For example, in progression 502A, LBA 0 has a generation number of 99, while LBA 2 has a generation number of 2. Accordingly, 97 more overwrite operations have targeted LBA 0 than LBA 2, illustrating that LBA 0 and its underlying data is more volatile than LBA 2 and its underlying data.

Each of the segments 512 include segment metadata 515A-D (e.g., in a segment header), referred to herein collectively as segment metadata 515, that is associated with corresponding portions of the segments 512. The segment metadata 515 may store CFI values 520 for the data associated with a corresponding portion of the segment 512. For example, as illustrated in segment metadata 515A, CFI values 520A-D correspond to data stored in corresponding portions of the segment 512A. Portions 516 of the segments 512 store valid data. The mapping 508 maps the LBAs 510 to these portions 516, indicating where data written to a particular LBA of the LBAs 510 is stored. For example, LBA 0 is mapped to a first one of the portions 516 of segment 512A storing valid data 517 A and LBA 1 is mapped to a second portion of 516 of segment 512A storing valid data 517B.

In the depicted example, for illustrative purposes, CFI values 520 that are not null in the segment metadata 515 correspond to one of the portions 516 for the corresponding segment 512, while CFI values 520 that are null may correspond to portions 518 storing invalid data 519 (as indicated by the hashing marks within the portions 518). For example in segment metadata 515A, the CFI value 520A of 1 corresponds to the first portion of the segment 512A storing valid data 517A, the CFI value 520B of 2 corresponds to the second portion of the segment 512A storing valid data 517B, the CFI value 520C of null corresponds to the third portion of the segment 512A storing invalid data 519, and the CFI value 520D of 1 corresponds to the fourth portion of segment 512A storing valid data 517C. While CFI values 520 of null are illustrated as associated with portions 518 storing invalid data 519, in some implementations, in lieu of null, these CFI values 520, may retain their prior CFI value 520 associated with the invalid data 519 and may be overwritten when a new corresponding valid data is written to the corresponding portion of the segment 512.

As may be appreciated from the mapping 508, the valid data has been placed in a frequency-based placement. Indeed, as illustrated, the data having similar generation numbers 514 and CFI values 520 has been stored in a common segment. For example, segment 512A stores data with generation numbers 514 in an example range of 80-100 and CFI values 520 in an example range of 1-3. Thus, LBAs 0, 1, and 994 are mapped to segment 512A and data associated with LBAs 0, 1, and 994 are written to segment 512A. Segment 512B stores data with generation numbers 514 in an example range of 0-3 and CFI values 520 in an example range of 10-20. Thus, LBAs 2, 3, and 8 are mapped to segment 512B and data associated with LBAs 2, 3, and 8 are written to segment 512C. Segment 512C stores data with generation numbers 514 in an example range of 4-15 and CFI values 520 in an example range of 5-10. Thus, LBAs 995 and 997 are mapped to segment 512C and data associated with LBAs 995 and 997 are written to segment 512C.

As indicated by the lack of arrows in the mapping 508 from the LBAs 510 to the segment 512D, the segment 512D is not currently holding valid data and, thus, is a segment that has been freed up for storing valid data (e.g., data copied forward via a garbage collection process and/or data of pending write IOs).

In FIG. 5B, prior to progression 502B, an overwrite operation 522 targeting LBA 8 may be provided (e.g., via a data writing system). As illustrated, the overwrite operation 522 may cause the generation number associated with LBA 8 to increment to 4 and cause LBA 8 to be mapped to a free segment storing the new data of LBA 8 with other data with similar generation numbers and CFI values. For example, data written to LBAs 998 and 999 between progressions 502A and 502B having similar generation numbers and/or CFI values may be written to segment 512D, as illustrated. The mapping 508 is updated, accordingly. Further, the former valid data of segment 512B mapped to LBA 8 in progression 502A becomes invalid data 519 in segment 512B.

In FIG. 5C, a garbage collection process 524 is running. The garbage collection process 524 is tasked with freeing up segments that include over a threshold level of fragmentation. Accordingly, in progression 502C, the garbage collection process 524 may identify that segment 512B of progression 502B of FIG. 5B now includes a level of fragmentation (e.g., a number and/or size of invalid data) that exceeds a fragmentation threshold (e.g., based upon the results of the overwrite operation 522 in progression 502B). Accordingly, the garbage collection process 524 may copy forward the valid data of segment 512B to a free segment (e.g. segment 512E) with additional data associated with similar generation numbers and/or CFI values. Thus, segment 512B may be freed up for subsequent storage of new data (not illustrated). Additionally, the CFI values associated with the copied forward data may be incremented (e.g., as illustrated in segment metadata 515E).

Thus, as illustrated by the progressions 502A-C of FIGS. 5A-B, whether through new write operations and/or a garbage collection processes, the techniques provided herein result in storing data with similar frequency statistics (e.g., generation number and/or CFI value) in common segments. This may lead to improved garbage collection, by reducing a number of copy forwards implemented by the garbage collection processes, resulting in significant processing resource efficiencies.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A storage system, comprising:
one or more processors; and
a non-transitory, computer-readable medium, comprising computer-readable instructions that are executable by the one or more processors to:
maintain, for each of a plurality of logical block addresses (LBAs) of a storage volume, a respective generation number comprising a count of overwrites to that LBA; and
maintain, for each of the plurality of LBAs, a respective copy forward index (CFI) comprising a count of times that given data written to that LBA has been copied forward to a free segment of a log-structured file system (LFS) of the storage volume; and
perform a garbage collection process, comprising:
identifying a set of segments of the LFS for garbage collection;
identifying valid data in the segments of the identified set of segments; and
coalescing the identified valid data into respective free segments based on similarity of CFI for the identified valid data and similarity of generation number corresponding to LBAs associated with the identified valid data.

2. The storage system of claim 1, wherein the non-transitory, computer-readable medium, comprises computer-readable instructions that are executable by the one or more processors to:
identify a plurality of sub-ranges of generation numbers covering a full range of generation numbers corresponding to the plurality of LBAs;
identify a plurality of sub-ranges of CFIs covering a full range of CFIs corresponding to the plurality of LBAs;
identify the similarity of CFI based upon the plurality of ranges of CFIs; and
identify the similarity of generation numbers based upon the plurality of ranges of generation numbers.

3. The storage system of claim 2, wherein the non-transitory, computer-readable medium, comprises computer-readable instructions that are executable by the one or more processors to:
maintain a plurality of open segments for storage of a plurality of pieces of pending data that have not yet been stored in the LFS, wherein each of the plurality of open segments is associated with one of a plurality of groups, the plurality of groups covering each combination of the plurality of sub-ranges of generation numbers and the plurality of sub-ranges of CFIs;
generate assignments for each of the plurality of pieces of pending data by assigning each of the plurality of pieces of pending data to an open segment of the plurality of open segments, based upon a respective generation number of that piece of pending data and a respective CFI of that piece of pending data; and
write each of the plurality of pieces of pending data to one of the plurality of open segments based upon the assignments.

4. The storage system of claim 3, wherein the non-transitory, computer-readable medium, comprises computer-readable instructions that are executable by the one or more processors to:
in response to identifying a full open segment based upon the assignments, write each of the pieces of pending data assigned to the full open segment to the full open segment.

5. The storage system of claim 3, wherein the non-transitory, computer-readable medium, comprises computer-readable instructions that are executable by the one or more processors to:
identify that an assigned piece of pending data is within a timeout threshold; and
in response to identifying that the assigned piece of pending data is within the timeout threshold, fill a partially full open segment that the assigned piece of pending data is assigned to with one or more other pieces of pending data of the plurality of pieces of pending data that are assigned to a different one of the plurality of open segments.

6. The storage system of claim 5, wherein the non-transitory, computer-readable medium, comprises computer-readable instructions that are executable by the one or more processors to:
select the one or more other pieces of pending data based upon at least one of:
the one or more other pieces of pending data being assigned to a neighboring partially full open segment; or
the one or more other pieces of pending data having an actual timeout closest to an actual timeout of the assigned piece of pending data.

7. The storage system of claim 1, comprising:
one or more page table entries that map each of the plurality of LBAs to a particular portion of physical storage of the storage system; and
wherein the non-transitory, computer-readable medium comprises computer-readable instructions that are executable by the one or more processors to:
maintain at least one of: the generation number of each of the plurality of LBAs or the CFI for the given data in the one or more page table entries.

8. The storage system of claim 1, comprising:
a plurality of segments of the LFS, wherein each of the plurality of segments comprises one of a plurality of segment headers; and
wherein the non-transitory, computer-readable medium comprises computer-readable instructions that are executable by the one or more processors to:
maintain at least one of: the generation number of each of the plurality of LBAs or the CFI of each of the plurality of LBAs in a respective one of the plurality of segment headers.

9. The storage system of claim 1, wherein the non-transitory, computer-readable medium, comprises computer-readable instructions that are executable by the one or more processors to:
in response to identifying an overwrite of data written to an LBA, resetting a respective CFI of that LBA to 0 .

10. A processor-implemented method, comprising:
maintaining, for each of a plurality of logical block addresses (LBAs) of a storage volume, a respective generation number comprising a count of overwrites to that LBA; and
maintaining, for each of the plurality of LBAs, a respective copy forward index (CFI) comprising a count of times that given data written to that LBA has been copied forward to a free segment of a log-structured file system (LFS) of the storage volume; and
performing a garbage collection process, comprising:
identifying a set of segments of the LFS for garbage collection;
identifying valid data in the identified set of segments; and
coalescing the identified valid data into respective free segments based on similarity of CFI for the identified valid data and similarity of generation number corresponding to LBAs associated with the identified valid data.

11. The processor-implemented method of claim 10, comprising:
identifying a plurality of sub-ranges of generation numbers covering a full range of generation numbers corresponding to the plurality of LBAs;
identifying a plurality of sub-ranges of CFIs covering a full range of CFIs corresponding to the plurality of LBAs;
identifying the similarity of CFI based upon the plurality of sub-ranges of CFIs; and
identifying the similarity of generation numbers based upon the plurality of sub-ranges of generation numbers.

12. The processor-implemented method of claim 11, comprising:
maintaining a plurality of open segments for storage of a plurality of pieces of pending data that have not yet been stored in the LFS, wherein each of the plurality of open segments is associated with one of a plurality of groups, the plurality of groups covering each combination of the plurality of sub-ranges of generation numbers and the plurality of sub-ranges of CFIs;
generating assignments for the plurality of pieces of pending data by assigning each of the plurality of pieces of pending data to an open segment of the plurality of open segments, based upon a respective generation number of that piece of pending data and a respective CFI of that piece of pending data; and
writing each of the plurality of pieces of pending data to one of the plurality of open segments based upon the assignments.

13. The processor-implemented method of claim 12, comprising:
in response to identifying a full open segment based upon the assignments, write each of the pieces of pending data assigned to the full open segment to the full open segment.

14. The processor-implemented method of claim 12, comprising:
identifying that an assigned piece of pending data is within a timeout threshold; and
in response to identifying that the assigned piece of pending data is within the timeout threshold, filling a partially full open segment that the assigned piece of pending data is assigned to with one or more other pieces of pending data of the plurality of pieces of pending data that are assigned to a different one of the plurality of open segments.

15. The processor-implemented method of claim 14, comprising:
selecting the one or more other pieces of pending data based upon at least one of:
the one or more other pieces of pending data being assigned to a neighboring partially full open segment; or
the one or more other pieces of pending data having an actual timeout closest to an actual timeout of the assigned piece of pending data.

16. The processor-implemented method of claim 10, comprising:
maintaining the generation number of each of the plurality of LBAs or the CFI of each of the plurality of LBAs in one or more page table entries that map each of the plurality of LBAs to a portion of physical storage; and
maintaining the CFI of each of the plurality of LBAs in segment metadata of a respective segment associated with that LBA.

17. A non-transitory, computer-readable medium, comprising computer-readable instructions that are executable by one or more processors to:
maintain, for each of a plurality of logical block addresses (LBAs) of a storage volume, a respective generation number comprising a count of overwrites to that LBA; and
maintain, for each of the plurality of LBAs, a respective copy forward index (CFI) comprising a count of times that given data written to that LBA has been copied forward to a free segment of a log-structured file system (LFS) of the storage volume; and
perform a garbage collection process, comprising:
identifying a set of segments of the LFS for garbage collection;
identifying valid data in the identified set of segments; and
coalescing the identified valid data into respective free segments based on similarity of CFI for the identified valid data and similarity of generation number corresponding to LBAs associated with the identified valid data.

18. The non-transitory, computer-readable medium of claim 17, comprising computer-readable instructions that are executable by the one or more processors to:
identify a plurality of sub-ranges of generation numbers covering a full range of generation numbers corresponding to the plurality of LBAs;
identify a plurality of sub-ranges of CFIs covering a full range of CFIs corresponding to the plurality of LBAs;
identify the similarity of CFI based upon the plurality of sub-ranges of CFIs; and
identify the similarity of generation numbers based upon the plurality of sub-ranges of generation numbers.

19. The non-transitory, computer-readable medium of claim 18, comprising computer-readable instructions that are executable by the one or more processors to:
maintain a plurality of open segments for storage of a plurality of pieces of pending data that have not yet been stored in the LFS, wherein each of the plurality of open segments is associated with one of a plurality of groups, the plurality of groups covering each combination of the plurality of sub-ranges of generation numbers and the plurality of sub-ranges of CFIs;
generate assignments for the plurality of pieces of pending data by assigning each of the plurality of pieces of pending data to an open segment of the plurality of open segments, based upon a respective generation number of that piece of pending data and a respective CFI of that piece of pending data; and
write each of the plurality of pieces of pending data to one of the plurality of open segments based upon the assignments.

20. The non-transitory, computer-readable medium of claim 19, comprising computer-readable instructions that are executable by the one or more processors to:
identify that an assigned piece of pending data is within a timeout threshold and is assigned to a partially full open segment; and
in response to identifying that the assigned piece of pending data is within the timeout threshold and is assigned to the partially full open segment, write one or more additional pending data that is assigned to a different partially full open segment to the partially full open segment.
